(19) United States
(12) Patent Application Publication
(10) Pub. No.: US 2008/0140641 A1
(43) Pub. Date: Jun. 12, 2008

(54) KNOWLEDGE AND INTERESTS BASED SEARCH TERM RANKING FOR SEARCH RESULTS VALIDATION

(75) Inventor: Jian Wang, San Jose, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/567,937

(22) Filed: Dec. 7, 2006

(51) Int. Cl. G06F 17/30

(52) U.S. Cl. 707/5; 707/E17.108

(57) ABSTRACT

Disclosed are apparatus and methods for verifying the ranking of search results, produced by a search algorithm executed for a particular search term. In certain embodiments, a plurality of users' knowledge and/or interest in specific categories are ranked to be used to calculate new rankings of search results, e.g., web pages based on search terms. Users may also be ranked by education level and field. These user rankings are then used to determine a new ranking of search results that are generated for a particular search term. For instance, the users that select (e.g., or click on) a particular search result cause a relevance score to be compiled based on such users' rankings in the categories to which the search results or search term belongs. Relevance scores are compiled for each search result that is selected by a plurality of users executing a plurality of searches. The new ranking of the search results for a particular search term is determined based on the relevance scores of such search results. It can then be determined whether the current ranking, produced for a particular search term by the search algorithm, is valid by comparing this new ranking to the current ranking.

### BACKGROUND OF THE INVENTION

The present invention is related to keyword search algorithms that are performed over a computer network, such as the Internet. It especially relates to validating a search algorithm's page ranking results.

A search algorithm typically operates to locate the web pages that contain one or more of the keywords, that are entered by a user, and then ranks such located pages based on various factors, such as the frequency and number of entered keywords that are within each page and the position of the entered keywords within each page. For instance, a first page that has a keyword located in the title or near the top of the page may be ranked higher than a second page that has a keyword in a footer or near the bottom of such second page. The located pages are then presented, based on their relative rankings, to the searcher. Typically, links to the located pages are presented to the user in a list format, from the highest to lowest rank.

Although a search algorithm may present pages in a ranked order that represents the most relevant search results for certain users, other users may find the rankings to be inadequate or irrelevant to their needs. Accordingly, it would be beneficial to verify the page ranking results of a search algorithm with respect to the specific needs or characteristics of a group of users.

### SUMMARY OF THE INVENTION

Accordingly, apparatus and methods for verifying the ranking of search results, produced by a search algorithm executed for a particular search term, are provided. In certain embodiments, a plurality of users' knowledge and/or interest in specific categories are ranked. Users may also be ranked by education level and field. These user rankings are then used to determine a new ranking of search results that are generated for a particular search term. For instance, the users that select (e.g., or click on) a particular search result cause a relevance score to be compiled based on such users' rankings in the categories to which the search results or search term belongs. Relevance scores are compiled for each search result that is selected by a plurality of users executing a plurality of searches. The new ranking of the search results for a particular search term is determined based on the relevance scores of such search results. It can then be determined whether the current ranking, produced for a particular search term by the search algorithm, is a good ranking by comparing this new ranking to the current ranking.

In one embodiment, a method for verifying the ranking of a plurality of search results that are produced by a search is disclosed. A particular search term is specified as belonging to one or more of the plurality of categories. For a plurality of users that initiate the searches on the particular search term to then produce a plurality of search results that have a current ranking, a relevance score for each of the search results is determined based on one or more particular users that select/click such each search result and the particular users' knowledge or interest in each category in which the particular search term belongs. The search results are ranked based on the obtained relevance scores of the search results so as to calculate a new ranking of the search results. It specifies whether the current ranking of the search results is valid based on comparing the current ranking to the newly calculated new ranking.

In a specific implementation, for each of a plurality of users, his or her knowledge and/or interest ranking is provided for each of a plurality of categories. Determining the relevance score for each search result is accomplished by, for each particular user that select/click such each search result, adding the particular user's knowledge and/or interest ranking for each category to which the particular search term is specified as belonging, so as to obtain the relevance score for the particular search result. In a further aspect, the relevance scores for each search result are determined over a predetermined period of time and wherein the new ranking of the search results is obtained for the predetermined period of time. In yet a further aspect, it is specified whether the current ranking is valid after the predetermined time period. In yet another aspect, the operations for determining the relevance scores and obtaining the new ranking are repeated for a plurality of predetermined time periods and the operation of specifying whether the current ranking is valid is repeated after each predetermined time period.

In another embodiment, the ranking for each category of each user is provided by either a first ranking that indicates no knowledge or interest in that category or a second ranking that indicates at least some knowledge or interest in the each category. In another embodiment, the ranking for each category of each user is provided by an ordinal number selected from a plurality of ordinal numbers from a lowest to a highest number. In yet another implementation, the ranking for each category of each user is automatically determined based on the each user's specified field of occupation and/or position. In an alternative implementation, the ranking for each category of each user is selected by the each user.

In another embodiment, the invention pertains to an apparatus having at least a processor and a memory. The processor and/or memory are configured to perform one or more of the above described operations. In another embodiment, the invention pertains to t least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 illustrates an example user search database in accordance with one implementation of the present invention.

FIG. 3 illustrates a category and search term data structure in accordance with one embodiment of the present invention.

FIG. 4A illustrates a user and category ranking data structure in accordance with a first implementation of the present invention.

FIG. 4B illustrates a user and category ranking data structure in accordance with a second implementation of the present invention.

FIG. 5 is a flowchart illustrating a procedure for verifying a current ranking of search results of a search algorithm in accordance with one embodiment of the present invention.

FIG. 6 is a simplified diagram of a network environment in which specific embodiments of the present invention may be implemented.

FIG. 7 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

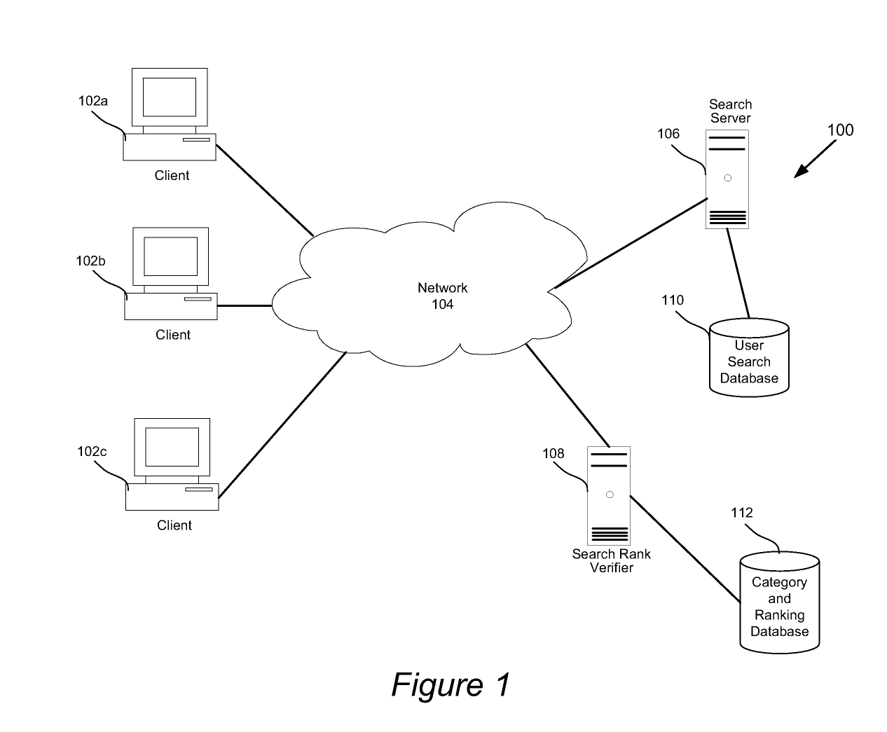

FIG. 1 illustrates an example network segment 100 in which the present invention may be implemented in accordance with one embodiment of the present invention. As shown, a plurality of clients 102 may access a search application, for example, on search server 106 via network 104. The network 104 may take any suitable form, such as a wide area network or Internet and/or one or more local area networks (LAN's). The network 104 may include any suitable number and type of devices, e.g., routers and switches, for forwarding search requests from each client to the search server and search results back to the requesting clients.

The search application may take any suitable form. For example, the search application may present a web page having any input feature to the client so the client can enter one or more search term(s). In a specific implementation, the search application includes an input box into which a user may type any number of search terms. Embodiments of the present invention may be employed with respect to any search application, and example search applications include Yahoo! Search, Google, Altavista, Ask Jeeves, etc. The search application may be implemented on any number of servers although only a single search server 106 is illustrated for clarity.

The search server 106 (or servers) may have access to one or more user search database(s) 110 into which search information is retained. Each time a user performs a search on one or more search terms, information regarding such search may be retained in the user search database(s) 110. For instance, the user's search request may contain any number of parameters, such as user or browser identity and the search terms, that may be retained in the user search database(s) 110. Additional information related to the search, such as the current time, may also be retained along with the search request parameters. When results are presented to the user based on the entered search terms, parameters from such search results may also be retained. For example, the specific search results, such as the web sites, the order or ranking in which the search results are presented, and which search result is selected by the user (if any) may also be retained in the user search database(s) 110.

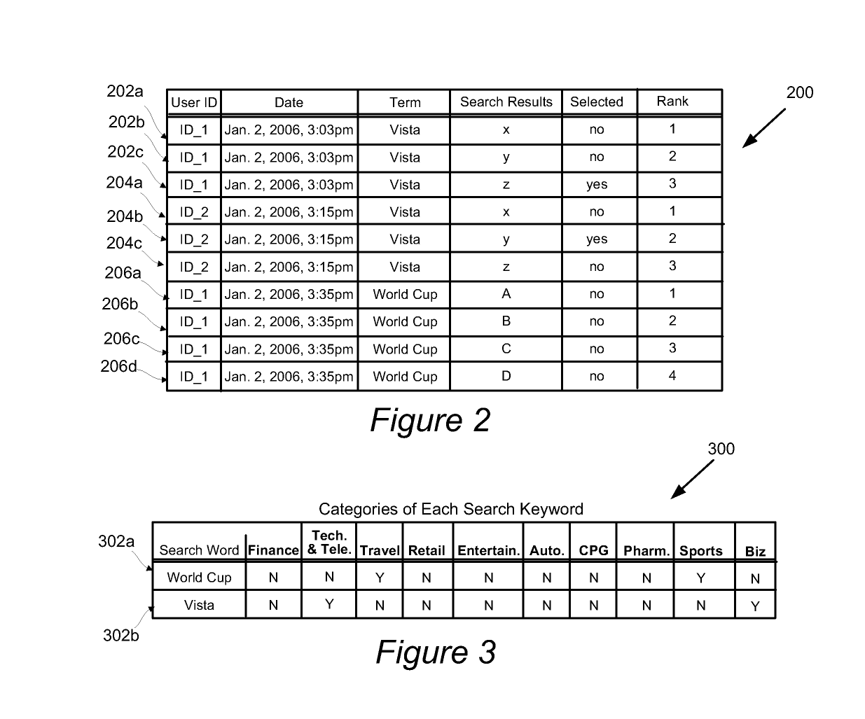

The user search database(s) may take any suitable form for retaining useful search information over time. FIG. 2 illustrates an example user search database 200 in accordance with one implementation of the present invention. As shown, the user search database 200 includes a plurality of entries 202a-202c for a first search by a first user ID_1, entries 204a-204c for a second search by a second user ID_2, and entries 206a-206d for a third search by the same first user ID_1. Each entry relates various parameters of a particular user's search for a particular search term and a particular search result. In the illustrated example, each entry includes a user identifier (ID), date, search term, search result, whether such search result was selected by the user, and the ranking of each search result with respect to the other search results produced for the same search. The Rank column in the table is the original ranking by the search algorithm. Alternatively, each entry may include a user ID and a plurality of searches that each includes a date, one or more search term(s) and their corresponding categories.

The user ID may correspond to any characteristic associated with the searcher, and the searcher may be a person or an automated entity. For embodiments of this invention, only searches by a registered human user are considered although in other embodiments, other types of users or identities may be considered. This ID may be associated directly with some form of a user's identity. By way of example, the user ID may be obtained from a user cookie.

The date field may correspond to any suitable time format, and may specify any combination of day, month, year, time, and time zone. The search term corresponds to a search term that was used in a specific search. A specific search may include more than one search term, which may be included in a different entry of the user search database. One or more category field (not shown) may be included in each user search entry to specify in which categories the search term of a specific search belongs.

In the present example, a separate entry may be formed for each search term and search result pair. For example, entries 202a-c each include a user ID equal to “ID_{—}1” and a date “Jan. 2, 2006, 3:03pm” for a first search on the search term “Vista”, which produces search results x, y, and z. A “no” in the Selected field of entries 202a and 202b indicate that such search results were not clicked (or selected) by the user ID_1. Entry 202c corresponds to search result “z”, which is indicated as selected by the user ID_1 (e.g., “yes” is indicated in the Selected field). Each search result may also be ranked in the Rank field. As shown, search results x, y, and z (from the same search on search term “Vista”) are ranked 1, 2, and 3, respectively, from a highest to lowest rank. As shown in entries 204a-204c, user ID_2 has also performed a search for search term “Vista”, but has selected the search result “y.” Lastly, entries 206a-206d correspond to a third search by user ID_1 for search term “Vista”, with no search results being selected by user ID_1.

In certain embodiments of the present invention, a search rank verifier 108 (FIG. 1) operates to verify the current ranking of the search results produced by the search algorithm, for example, on particular search keywords and as presented to users of the search application 106. The search rank verifier also has access to the user search database(s) 110, as well as one or more category and ranking database(s) 112. Of course, any portion of the category and ranking databases 112 described herein may be integrated with the user search database 110. In this example, the category and ranking database(s) 112 specify the division of a plurality of search terms among specific search categories and rankings of user knowledge and/or interest in each category. In one implementation, the search categories each relate to a particular product or service category. In one example implementation, the categories include finance, technology and telecommunications, travel, retail, entertainment, automotive, CPG (consumer packaging group), and pharmaceutical. Other category choices may also be used, such as arts, business, computer, health, politics, sports, etc.

The category and ranking database(s) 112 may include any suitable data structure for specifying in which search categories a particular search term belongs. FIG. 3 illustrates a category and search term data structure 300 in accordance with one embodiment of the present invention. In this example, each entry 302 includes a search term and specifies to which categories such search term belongs. In this implementation, each search term is associated with a plurality of different category fields that are set to “y” (i.e., yes) or “n” (i.e., no), depending on whether the search term belongs to such category. For example, entry 302a corresponds to the search term “World Cup” and specifies that this search term belongs to the “travel” and “sports” category. Entry 302b corresponds to the search term “Vista” and specifies that this search term belongs to the “Technology and Telecommunications” and “Biz” categories.

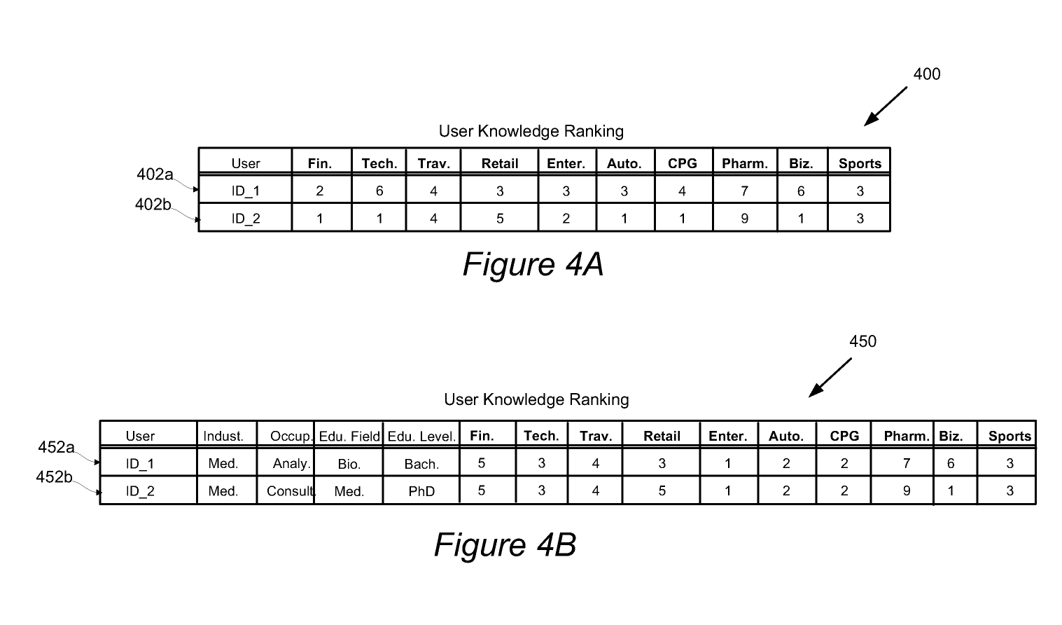

The category and ranking database(s) 112 may also include any suitable data structure for specifying one or more rankings for knowledge and/or interest in each category for each user. Each user may also be ranked based on education level. FIG. 4A illustrates a user and category ranking data structure 400 in accordance with a first implementation of the present invention. As shown, each entry 402a and 402b include a ranking for each of a plurality of categories and a particular user. For instance, entry 402a includes a user field for specifying a user identity ID_1 and a plurality of category fields for specifying a ranking of user ID_1's level of knowledge or interest in each category. Entry 402b includes rankings for user ID_2's knowledge and/or interest in each of a plurality of categories.

The user knowledge/interest rankings for each category may be binary and specify one of two values, such as 1 or 0. A first ranking value, e.g., 1, may indicate that the user has at least some knowledge and/or interest in the corresponding category, while a second ranking value, e.g., 0, may indicate that the user has no knowledge or interest in the corresponding category. In another implementation, the user ranking for each category may be selected from a plurality of ordinal numbers from a highest to low number. In the example of FIG. 4A, rankings are selected from ordinal numbers 1 through 10, with 1 being the lowest ranking and 10 being the highest ranking. Any suitable ranking scale may be implemented with any suitable range and with integer or whole numbers.

The user knowledge ranking values for each user may be obtained in any suitable manner. For example, when a user registers with a search service, such as Yahoo!, and creates an account, the user may enter information to indicate his/her knowledge and/or interest in each category. When registering for an account, the user may enter an identity, password, and knowledge rankings values selected from numbers 1-10 or from a binary set of values, by way of example. The user may be allowed to enter this information via input boxes, checkboxes, pull-down menus, etc. that are presented in a user interface. After the user enters ranking information, the rankings are associated with the user's identity and stored, e.g., in data structure 400 and database 112.

In other implementations, the user's rankings for particular categories may be implied from other information associated with the user. For instance, rankings may be set for each category based on a user's occupation position and/or field and/or education field and/or education level. That is, a user's knowledge and/or interest in each category may be automatically set based on the user's position and/or field of occupation and/or education level and/or field. In a specific implementation, a user may select from a plurality of defined occupational fields and positions and each set of selected fields and positions correspond to specific rankings in specific categories. In another example, the user also selects from a plurality of education fields and levels and his/her rankings in specific categories is based on his/her education level, education field, occupation field, and occupation field. Alternatively, the user may select rankings for each category and enter their education and work information, whereupon a separate ranking is automatically set for the education level and/or work information. That is, a single user may have more than one ranking: a ranking for knowledge/interest in each category, a ranking for education field and education level, and a ranking for occupational position and field.

FIG. 4B illustrates a user and category ranking data structure 450 in accordance with a second implementation of the present invention. In this example, each entry 452a and 452b corresponds to a user's industry of occupation (Indust.), occupation (Occup.), education field, education level, and a plurality of category rankings that have been automatically set based on such industry, occupation, education field, and education level selections. As mentioned earlier, there may also be a separate ranking for education level and field for each user. As shown, users ID_1 and ID_2 are both in the medical industry. Other industry fields may include aerospace, agriculture, automotive, computer, service, etc. User ID_1 has an analyst occupational position, while user ID_2 has a consultant position. Other occupation positions may include programmer, project manager, researcher/scientist, system architecture, etc.

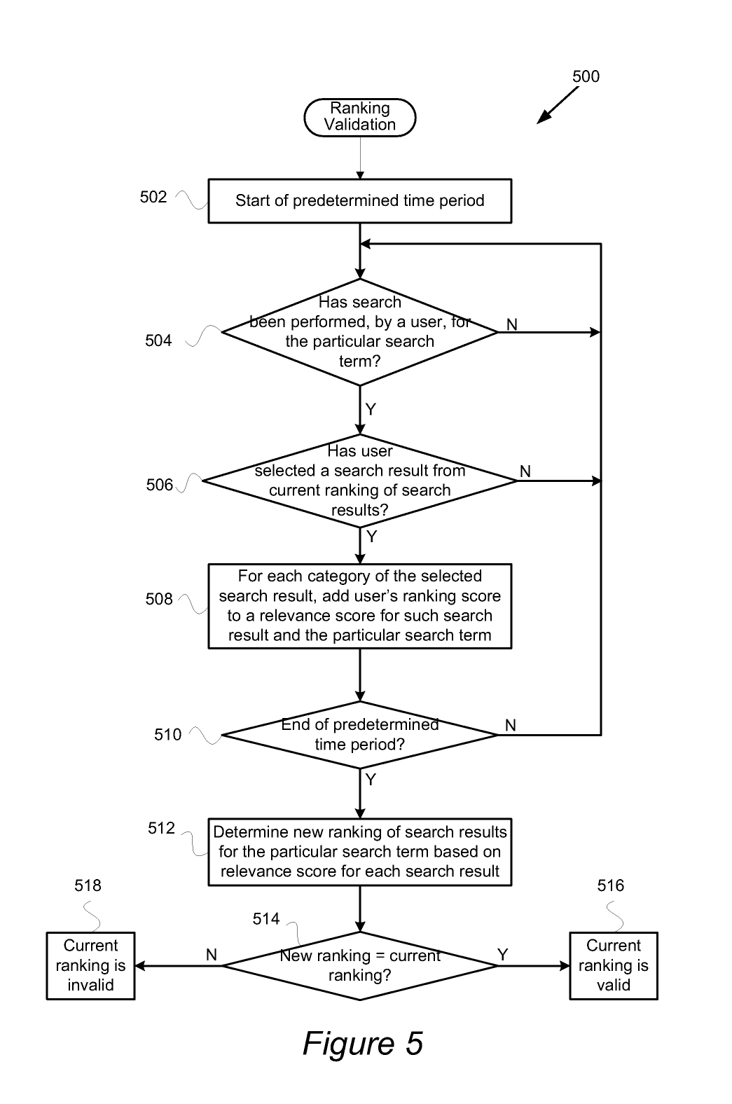

Once a user's category rankings (and possibly other types of rankings) and the categories to which each search term belongs have been retained, the current ranking of search results that is determined by a search algorithm, for a particular search term, may be verified. FIG. 5 is a flowchart illustrating a procedure 500 for verifying a current ranking of search results of a search algorithm in accordance with one embodiment of the present invention. The following procedure 500 may be used to verify the current ranking of search results produced by a search algorithm for a particular search term. Of course, this same procedure can be performed for any number of search terms and also may be repeated periodically for the same search term, for example, to verify periodic updates to the search algorithm. Also, the following verification procedure includes operations that are performed after each search for a particular search term (search result scores are determined). However, the following procedure may be performed after a plurality of searches have been performed. For example, the user search database may be accessed and used to verify searches that were already executed over a period of time.

Referring to FIG. 5, a predetermined time period may start in operation 502. That is, this verification procedure may be applied over a predetermined time frame, such as a month or a week. It may then be determined whether a search has been performed by a user for the particular search term in operation 504. If not, the procedure may skip the user. After a search has been performed, it may then be determined whether the user (who initiated the current search) has selected a search result from the current ranking of search results in operation 506.

A user may select a search result in any suitable manner. For example, the search algorithm may produce and present a plurality of search results to the user in a ranked list of links to such search results, in an order from highest to lowest rank. The search algorithm may also only present a subset of the total search results generated for a particular search term. Each link may be in the form of a hypertext link to a web page and when a user selects a search result's link, the user is presented with the web page corresponding to the selected link.

When a user has selected a particular search result, the user's ranking score for each category of the selected search result (e.g., to which the selected search result belongs) may be added to a relevance score for such search result and its particular search term in operation 508. That is, a relevance score may be compiled for each search term and selected search result pair based on the selecting-users' knowledge and/or interest rankings in one or more categories in which the search result belongs.

In the search examples of FIG. 2 for the search term “Vista”, two users ID_1 and ID_2 have performed a search with the same search results x, y, and z. User ID_1 selected search result “z”, while user ID_2 selected search result “y.” FIG. 3 specifies this search term “Vista” as belonging to the categories “Technology and Telecommunications” and “Biz.” Additionally, the User Knowledge Ranking data structure of FIG. 4B indicates that user ID_1 has a ranking of 3 and 6 in the “Technology and Telecommunications” and “Biz” categories, respectively. Similarly, user ID_1 has ranking of 3 and 1 in these same categories.

Since the user ID_1 selected search result “z” has rankings of 3 and 6 in the “Technology and Telecommunications” and “Biz” categories of the search term “Vista”, this user's rankings (3+6) are added to the relevance score for search result z to achieve a total score of 9. As other users search on the term “Vista” and select this same search results “z”, their rankings in the “Technology and Telecommunications” and “Biz” categories will also be added to the total relevance score for search result “z.” For the search result “y”, since the user ID_2 that selected this search result has rankings of 3 and 1 in the “Technology and Telecommunications” and “Biz” categories of the search term “Vista”, this user's rankings (3+1) are added to the relevance score for search result y to achieve a total score of 4. Since no users have yet selected search result “x”, the relevance score is 0 for search result “x.” If there was an education ranking for each user, the education ranking for user ID_1 would be added to the relevance score of search result “z”, while the education ranking for user ID_2 would be added to the relevance score of search result “y.” In the current example, search results for search term “Vista” have a compiled ranking of z, y, and x, from highest to lowest rank, for now although this could change as more users with different rankings for the “Technology and Telecommunications” and “Biz” categories search for “Vista” and select specific search results.

It may then be determined whether the predetermined time period has ended in operation 510. If the time period has not ended, the procedure may be repeated for the next user's search on the particular search term and his/her selected search result (if any). When the predetermined time period is over, a new compiled ranking of the search results (that are produced for the particular search term) may be determined based on the relevance score for each search result in operation 512. In the above example for search term “Vista”, the new ranking is z, y, and x.

The current ranking that is produced by the search algorithm for the particular search term may then be verified based on the user's knowledge and/or interest rankings in any suitable manner. In the present example, it may then be determined whether the newly determined/compiled ranking equals the current ranking in operation 514. If the new ranking is the same as the current ranking, it may be determined that the current ranking is valid in operation 516 (implying that the algorithm has a good web page ranking based on the entered search term). Otherwise, it may be determined that the current ranking is not valid or is not a good ranking in operation 518. In the above example, the new ranking (z, y, and x) differs from the current ranking (x, y, and z) so that it is concluded that the current ranking is invalid.

In a further embodiment, the validation outcome may be utilized to adjust the search algorithm so as to produce more accurate rankings. Several embodiments of techniques for performing ranking are further described in co-pending U.S. application Ser. No. 11/474,195 filed 22 Jun. 2006 by Pavel Berkhin et al., which application is incorporated herein by reference in its entirety for all purposes. These ranking techniques may be adjusted so as to produce the new ranking for a particular search term. For example, a scaling factor may be used for each search result so as to cause the search result's relevance to be adjusted according to the new rankings.

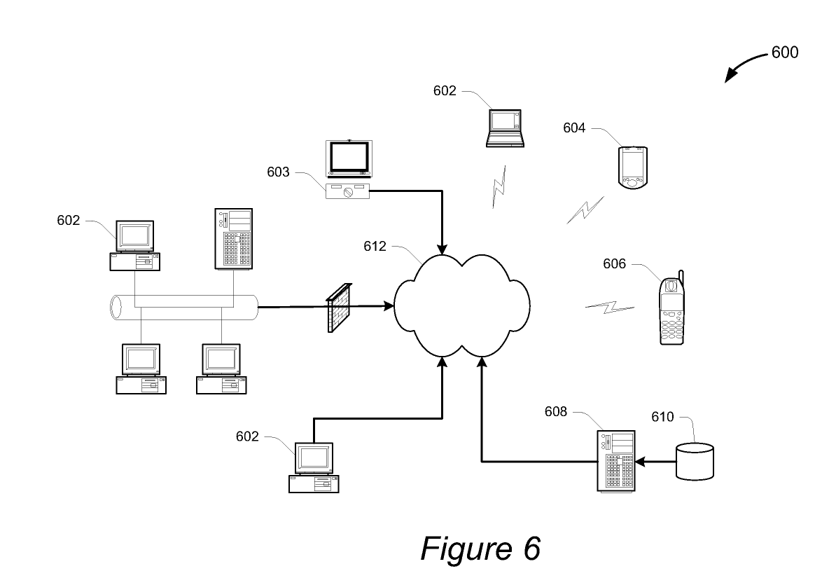

Embodiments of the present invention may be employed to perform searches and obtain ranking information in any of a wide variety of computing contexts. For example, as illustrated in FIG. 6, implementations are contemplated in which the relevant population of users interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

And according to various embodiments, user and search information may be obtained using a wide variety of techniques. For example, user knowledge/interest/education rankings and search information representing a user's interaction with a local application, web site or web-based application or service may be accomplished using any of a variety of well known mechanisms for recording a user's behavior. However, it should be understood that such methods are merely exemplary and that status information may be collected in many other ways.

Once categories, rankings, and search information have been obtained, this information may be handled according to the invention in some centralized manner. This is represented in FIG. 6 by server 608 and data store 610 that, as will be understood, may correspond to multiple distributed devices and data stores. The invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

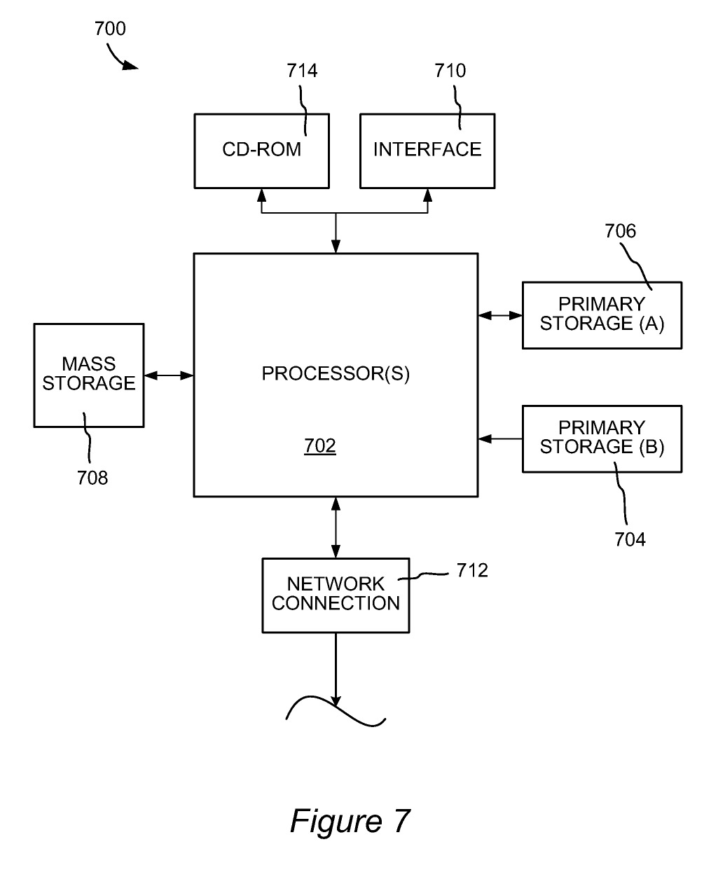

FIG. 7 illustrates a typical computer system that, when appropriately configured or designed, can serve as a search engine and/or search rank verifier. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described herein. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store user search information, search term categories, user category and education rankings, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for verifying the ranking of a plurality of search results that are produced by a search, comprising:
specifying a particular search term as belonging to one or more of the plurality of categories;
for a plurality of users that initiate the search on the particular search term to then produce a plurality of search results that have a current ranking, determining a relevance score for each of the search results based on one or more particular users that select or click such each search result and the particular users' knowledge or interest in each category in which the particular search term belongs; and
ranking the search results based on the determined relevance scores of the search results so as to calculate a new ranking of the search results; and
specifying whether the current ranking of the search results is valid based on comparing the current ranking to the calculated new ranking of the search results.

2. A method as recited in claim 1, further comprising for each of a plurality of users, providing a knowledge and/or interest ranking for each of a plurality of categories, and wherein the operation of determining the relevance score for each search result is accomplished by, for each particular user that select or click such each search result, adding the particular user's knowledge and/or interest ranking for each category to which the particular search term is specified as belonging, so as to determine the relevance score for the particular search result.

3. A method as recited in claim 2, wherein the relevance scores for each search result are determined over a predetermined period of time and wherein the new ranking of the search results is obtained after the predetermined period of time.

4. A method as recited in claim 3, wherein it is specified whether the current ranking is valid for the predetermined time period.

5. A method as recited in claim 3, further comprising repeating the operations for determining the relevance scores and calculating the new ranking for a plurality of predetermined time periods and repeating the operation of specifying whether the current ranking is valid for each predetermined time period.

6. A method as recited in claim 2, wherein the ranking for each category of each user is provided by either a first ranking that indicates no knowledge or interest in the each category or a second ranking that indicates at least some knowledge or interest in the each category.

7. A method as recited in claim 2, wherein the ranking for each category of each user is provided by an ordinal number selected from a plurality of ordinal numbers from a lowest to a highest number.

8. A method as recited in claim 2, wherein the ranking for each category of each user is automatically determined based on the each user's specified field of occupation and/or position.

9. A method as recited in claim 2, wherein the ranking for each category of each user is selected by the each user.

10. An apparatus comprising at least a processor and a memory, wherein the processor and/or memory are configured to perform the following operations:
specifying a particular search term as belonging to one or more of the plurality of categories;
for a plurality of users that initiate a plurality of searches on the particular search term to then produce a plurality of search results that have a current ranking, determining a relevance score for each of the search results based on one or more particular users that select such each search result and the particular users' knowledge or interest in each category in which the particular search term belongs; and
ranking the search results based on the determined relevance scores of the search results so as to calculate a new ranking of the search results; and
specifying whether the current ranking of the search results is valid based on comparing the current ranking to the calculated new ranking of the search results.

11. An apparatus as recited in claim 10, wherein the processor and/or memory are further configured to, for each of a plurality of users, provide a knowledge and/or interest ranking for each of a plurality of categories, and wherein determining the relevance score for each search result is accomplished by, for each particular user that select such each search result, adding the particular user's knowledge and/or interest ranking for each category to which the particular search term is specified as belonging, so as to determine the relevance score for the particular search result.

12. An apparatus as recited in claim 11, wherein the relevance scores for each search result are determined over a predetermined period of time and wherein the new ranking of the search results is calculated for the predetermined period of time.

13. An apparatus as recited in claim 12, wherein the processor and/or memory are further configured to repeat the operations for determining the relevance scores and obtaining the new ranking for a plurality of predetermined time periods and repeat the operation of specifying whether the current ranking is valid for each predetermined time period.

14. An apparatus as recited in claim 11, wherein the ranking for each category of each user is automatically determined based on the each user's specified field of occupation and/or position.

15. An apparatus as recited in claim 11, wherein the ranking for each category of each user is selected by the each user.

16. At least one computer readable storage medium having computer program instructions stored thereon that are arranged to perform the following operations:
specifying a particular search term as belonging to one or more of the plurality of categories;
for a plurality of users that initiate a plurality of searches on the particular search term to then produce a plurality of search results that have a current ranking, determining a relevance score for each of the search results based on one or more particular users that select such each search result and the particular users' knowledge or interest in each category in which the particular search term belongs; and
ranking the search results based on the determined relevance scores of the search results so as to calculate a new ranking of the search results; and
specifying whether the current ranking of the search results is valid based on comparing the current ranking to the calculated new ranking of the search results.

17. At least one computer readable storage medium as recited in claim 16, wherein the computer program instructions stored thereon that are further arranged to, for each of a plurality of users, provide a knowledge and/or interest ranking for each of a plurality of categories, and wherein determining the relevance score for each search result is accomplished by, for each particular user that select such each search result, adding the particular user's knowledge and/or interest ranking for each category to which the particular search term is specified as belonging, so as to determine the relevance score for the particular search result.

18. At least one computer readable storage medium as recited in claim 17, wherein the relevance scores for each search result are determined over a predetermined period of time and wherein the new ranking of the search results is calculated for the predetermined period of time.

19. At least one computer readable storage medium as recited in claim 18, wherein it is specified whether the current ranking is valid for the predetermined time period.

20. At least one computer readable storage medium as recited in claim 18, wherein the computer program instructions stored thereon that are further arranged to repeat the operations for determining the relevance scores and calculating the new ranking for a plurality of predetermined time periods and repeat the operation of specifying whether the current ranking is valid for each predetermined time period.

21. At least one computer readable storage medium as recited in claim 17, wherein the ranking for each category of each user is provided by either a first ranking that indicates no knowledge or interest in the each category or a second ranking that indicates at least some knowledge or interest in the each category.

22. At least one computer readable storage medium as recited in claim 17, wherein the ranking for each category of each user is provided by an ordinal number selected from a plurality of ordinal numbers from a lowest to a highest number.

23. At least one computer readable storage medium as recited in claim 17, wherein the ranking for each category of each user is automatically determined based on the each user's specified field of occupation and/or position.

24. At least one computer readable storage medium as recited in claim 17, wherein the ranking for each category of each user is selected by the each user.
